(19) United States
(12) Patent Application Publication
(10) Pub. No.: US 2012/0307247 A1
(43) Pub. Date: Dec. 6, 2012

(54) Fluorescence Microscopy Method And System

(75) Inventors: Piau Siong Tan, Singapore (SG); Xiaocong Yuan, Singapore (SG)

(73) Assignee: Nanyang Technological University, Singpagore (SG)

(21) Appl. No.: 13/149,620

(22) Filed: May 31, 2011

(51) Int. Cl. G01N 21/55

(52) U.S. Cl. 356/445

(57) ABSTRACT

A fluorescence microscopy method and system, the method comprising the steps of applying optical vortices to a metal surface for generating surface plasmon resonance (SPR) waves at the metal surface; and collecting fluorescence light excited by the SPR waves; wherein a dynamic characteristic of the optical vortices is controlled for controlling interference patterns of the SPR waves.

### FIELD OF INVENTION

The present invention relates broadly to a fluorescence microscopy method and system.

### BACKGROUND

Optical microscopy plays an important role for a large number of applications e.g. in the life sciences and biological research areas. It allows one to work with intact samples including the study of living cells in their native environment, which is not feasible with many higher-resolution methods such as electron microscopy. Even though there are several scanning-probe methods with higher resolutions such as atomic force microscopy, there is significant resolution degradation in soft biological specimens when such methods are used. Also, atomic force microscopy, for example, is inherently slow due to point-by-point scanning.

Among the major developments in optical microscopy in the past century, fluorescence-based microscopy remains the most widely used imaging tool in many biology applications due to its non-invasive properties and its feasibility compared to other higher-resolution imaging techniques. However, like all optical imaging tools, it suffers from the fundamental resolution limitation. Further, while resolution is typically denoted by the ability to discern different objects, much effort has been devoted to improving spatial resolution of far-field fluorescence microscopy.

Existing far-field fluorescence microscopy techniques include stimulated emission depletion (STED) microscopy, saturated structured illumination microscopy (SSIM), structured illumination microscopy (SIM), and harmonic excitation light microscopy (HELM).

STED has achieved the highest resolution of smaller than 30 nanometers (nm) using nonlinear photon-induced saturation depletion of the excited state in the outer regions of the excitation point spread function (PSF). However, this technique suffers from relatively slow speed due to the point scanning nature. SSIM uses a wide-field (WF) mode and provides comparable super-resolution to STED. However, the photobleaching effect in SSIM is particularly significant e.g. under saturating light intensities. Both SIM and HELM use WF camera detection, allowing faster image acquisition by encoding either the diffraction grating illumination structure or the standing wave (SW) illumination. This can result in a high-frequency patterned illumination onto a specimen, providing up to a two-fold lateral resolution enhancement. However, most of the SIM techniques are using diffraction grating illumination (which requires an expensive fabrication process) or standing-wave illumination (which has the limitations such as low signal-to-noise ratio and higher background noise, as described below with respect to SW-TIRF). On the other hand, HELM utilises the spatially harmonic distribution generated in the object plane by using interference of the laser or imaging of phase gratings; thus, the setup is complex and needs high accuracy of optical configuration, in the same way as SW-TIRF.

Another existing technique to improve lateral resolution in WF mode uses a combination of standing-wave (SW) illumination and total internal reflection fluorescence (TIRF). Evanescent SW keeps the SW spacing narrower due to a higher refractive index of the substrate, resulting in enhanced resolution. Since phase shift is in principle fast, SW-TIRF does not necessarily increase the total image acquisition time compared to conventional WF imaging. Resolution down to 100 nm can be realized by this technique. However, the transmission intensity of SW-TIRF is relatively low, and it may have the drawbacks of low contrast and low signal-to-noise ratio. Also, existing implementations of SW-TIRF require the use of mechanical stages involving moving parts for manually controlling an optical path difference, and are thus susceptible to environment noise such as vibration.

A need therefore exists to provide a fluorescence microscopy method and system that seek to address at least some of the above problems.

### SUMMARY

In accordance with a first aspect of the present invention, there is provided a fluorescence microscopy method, comprising the steps of:

applying optical vortices to a metal surface for generating surface plasmon resonance (SPR) waves at the metal surface; and

collecting fluorescence light excited by the SPR waves;

wherein a dynamic characteristic of the optical vortices is controlled for controlling interference patterns of the SPR waves.

The dynamic characteristic of the optical vortices may comprise a topological charge; the method may further comprise controlling a radius of the optical vortices based on the topological charge.

The method may further comprise modulating a phase of the interference patterns based on the topological charge.

The method may further comprise generating at least three intermediate images each corresponding to a respective phase.

The method may further comprise applying a deconvolution algorithm to the intermediate images to convert original point spread functions (PSFs) into single-lobed PSFs.

The radius may be matched against an SPR angle corresponding to a respective sample.

In accordance with a second aspect of the present invention, there is provided a fluorescence microscopy system, comprising:

means for applying optical vortices to a metal surface for generating surface plasmon resonance (SPR) waves at the metal surface;

means for collecting fluorescence light excited by the SPR waves; and

means for controlling a dynamic characteristic of the optical vortices for controlling interference patterns of the SPR waves.

The dynamic characteristic of the optical vortices may comprise a topological charge, and the means for controlling the dynamic characteristic of the optical vortices may control a radius of the optical vortices based on the topological charge.

The system may further comprise means for modulating a phase of the interference patterns based on the topological charge.

The system may further comprise means for generating at least three intermediate images each corresponding to a respective phase.

The system may further comprise means for applying a deconvolution algorithm to the intermediate images to convert original point spread functions (PSFs) into single-lobed PSFs.

The radius may be matched against an SPR angle corresponding to a respective sample.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(a) shows a schematic diagram of a fluorescence microscopy system according to an example embodiment.

FIG. 1(b) shows an enlarged view of an example optical configuration of the fluorescence microscopy system, as denoted by the dotted lines in FIG. 1a.

FIG. 1(c)-1(d) show schematic diagrams illustrating surface plasmon resonance according to an example embodiment.

FIG. 2 shows a schematic diagram illustrating an experimental setup for implementing the system of FIG. 1.

FIGS. 3(a)-3(d) show simulation results illustrating excitation intensity profiles generated by a linearly polarized OV beam having a topological charge of 1, 2, 3, and 4 respectively.

FIG. 4 shows simulation results comparing performance of a conventional TIRF technique and the SW-SPRF method of the example embodiment.

FIG. 5 shows experimental results after carrying progressive steps of the fluorescence microscopy method according to a preferred embodiment.

FIG. 6 shows a flow chart illustrating a fluorescence microscopy method according to an example embodiment.

FIG. 7 shows a schematic block diagram illustrating a computer system suitable for use in the method and system of the example embodiments.

### DETAILED DESCRIPTION

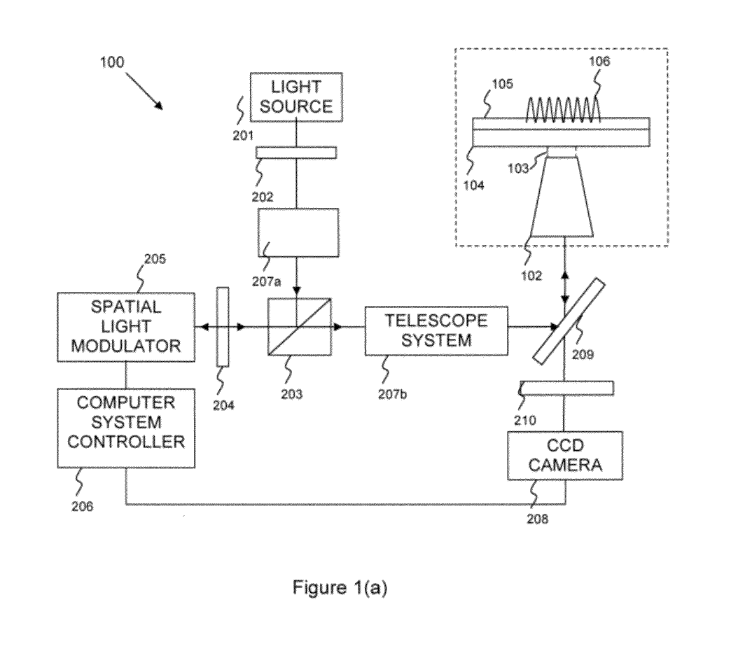

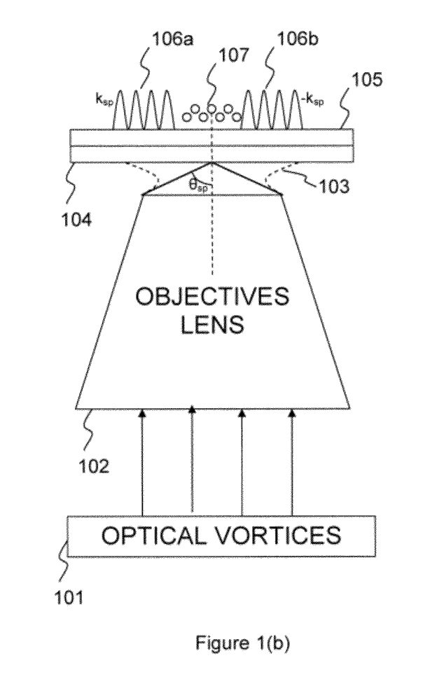

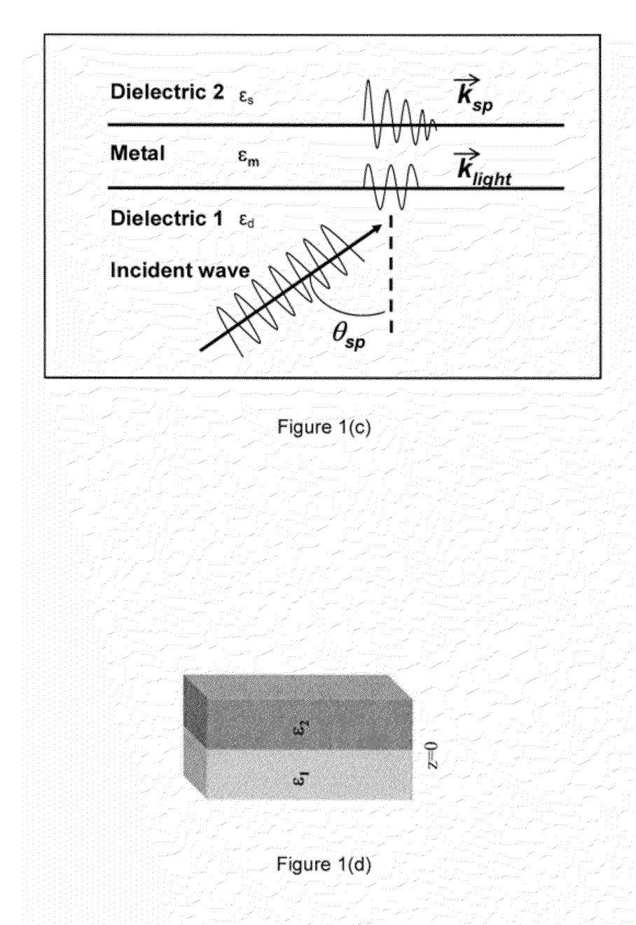

FIG. 1(a) shows a schematic diagram of a fluorescence microscopy system 100 according to an example embodiment. FIG. 1(b) shows an enlarged view of an example optical configuration of the fluorescence microscopy system 100, as denoted by the dotted lines in FIG. 1(a).

As shown in FIG. 1a, a series of optics direct an incident light beam generated from a coherent light source 201, such as a laser source, to generate surface plasmon polariton (SPP) waves 106a, 106b on a metal surface 105. In an example embodiment, the incident light beam from the light source 201 is polarized by a polarizer 202. The size of the polarized light beam is adjusted by a lens system 207a in the example embodiment. A beam splitter 203 directs the polarized light to a spatial light modulator (SLM) 205 via a halfwave plate 204. The SLM 205, e.g. a parallel-aligned nematic liquid crystal, is used in the example embodiment to imprint computer-generated patterns of phase shifts onto the wavefront of the incident light beam for forming an optical vortex (OV). In addition, a system controller in the form of a computer 206 is coupled to the SLM 205, and controls the phase modulation.

The modulated wavefront is collected by the beam splitter 203 and is transferred by a telescope system 207b to a back aperture of a total internal reflection fluorescent (TIRF) objective lens 102, e.g. via dichroic mirror 209, in the example embodiment. The objective lens 102 focuses the OV onto the metal surface 105, which is deposited on a glass substrate 104, for generating SPPs. Features of interest in a sample (not shown), which can inherently have chromophoric or scattering properties, or be tagged with suitable chromophores or scatterers during fabrication so that the recorded images are indicative of the feature of interest, are represented in the example embodiment by fluorescent polystyrene microspheres 107. The fluorescence polystyrene microspheres 107 are excited by the localized SPPs. In the example embodiment, the fluorescence emission is collected by the same objective lens 102 and the emitted light images are transmitted to a charge-coupled device (CCD) camera 208 through the dichroic mirror 209 along the emission path after the filtration of reflected incident light by a notch filter 210. In an example embodiment, the COD camera 208 is coupled to the computer 206 for processing the captured images.

With reference to FIG. 1b, when an optical vortex (OV) 101 emanates from the oil-immersion 103 objective lens 102 and converges towards the geometric focus, it gives rise to a diffraction-limited spot containing a large spectrum of wavevectors limited by the numerical aperture (NA) of the lens 102. Therefore, in an example embodiment, by selecting two sets of diametrically opposed waves with surface plasmon resonance (SPR) angles of ±θₛₚ, two counter propagating SPP waves 106a, 106b with wavevector of ±kₛₚ are generated (described in detail below) on the metal surface 105, which is deposited on the glass substrate 104. The SPP waves 106a, 106b propagate towards the OV beam center to form a localized standing wave SW field if the SPP propagation length is longer than the radius of the focused OV on the surface 104/105. Due to such an excitation scheme, the SPPs are highly confined near the interface between the metal and the sample, and are intrinsically localized in a small volume. In the example embodiment, this results in a spatial localization to dimensions smaller than the wavelength with high-spatial-frequency information, thereby improving the imaging resolution. These SPP waves 106 subsequently excite fluorescent beads 107 on the metal surface 105 (as mentioned above). The phase modulation of the interference fringe of the SPP waves 106 can be controlled by controlling the topological charge via the computer system 206.

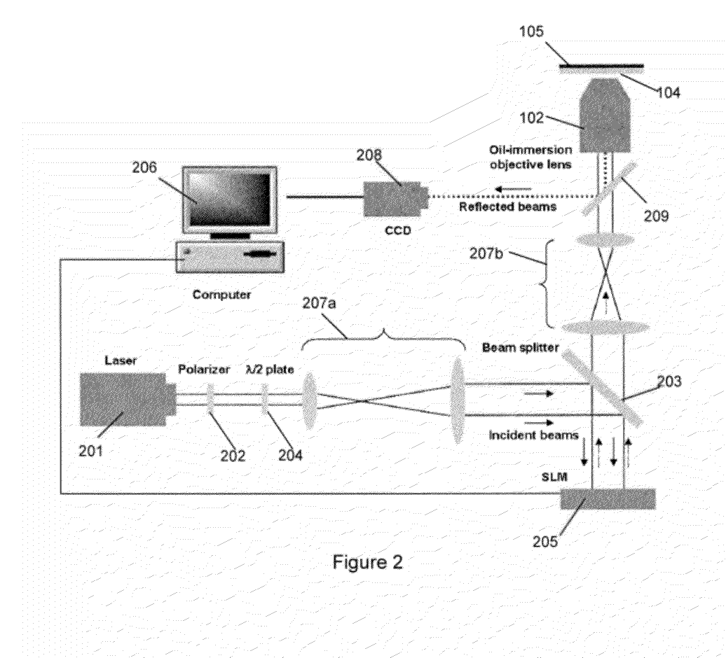

FIG. 2 shows a schematic diagram illustrating an experimental setup for implementing the system 100 of FIG. 1. In FIG. 2, the same components are shown with the same reference numerals as those used in FIGS. 1a, 1b.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Typically, the SPPs have a characteristic momentum defined by factors that include the nature of the conducting film (e.g. the metal surface 105) and the properties of the medium (dielectric) on either side of the film. The momentum of the surface plasmon (SP), p, is determined by its wavevector kₛₚ:

p=hk_{SP} (1)

where h is the Dirac constant.

By solving the Maxwell's equations under the appropriate boundary conditions, the SP dispersion relation that is the frequency-dependent SP wavevector is given as:

$${k}_{SP} = \frac{{ω}_{0}}{c} \sqrt{\frac{{ɛ}_{s} {ɛ}_{m}}{{ɛ}_{s} + {ɛ}_{m}}} \qquad ( 2 )$$

where ω₀ is the plasmon frequency, c is the speed of light in a vacuum, εₘ is the dielectric constant of the metal and εₛ is the dielectric constant of the dielectric medium where the fluorescence beads are disposed (e.g. air in the example embodiment).

It will be appreciated that the metal film 105 (FIG. 1) does not impede the collection of the fluorescent light emitted in the example embodiment as there is a strong surface plasmon coupling emission (SPCE) effect back to the CCD camera 208. In a preferred embodiment, the thickness of the metal film 105 is between 40 nm to 80 nm in order to generate the surface plasmon resonance. Also, the refractive index of the glass substrate 104 is match with that of the immersion oil 103 in the example embodiment.

FIG. 1(c)-1(d) show schematic diagrams illustrating surface plasmon resonance according to an example embodiment. With reference to FIGS. 1(c) and 1(d), a detailed discussion of the above equations is now provided.

As shown in FIG. 1(c), the incident optical wavevector k_{light} can be expressed as:

$${k}_{light} = \frac{{ω}_{0}}{c} \sqrt{{ɛ}_{d}} sin {θ}_{SP} \qquad ( 2.1 )$$

where θₛₚ is the resonance angle, ε_{d} is the dielectric constant of dielectric 1, here, the glass substrate 104.

For an ideal surface, if waves are to be formed that propagate along the interface there must necessarily be a component of the electric field normal to the surface.

Therefore, s-polarized surface oscillations, which electric field E is parallel to the interface, do not exist, whereas the traveling wave with the magnetic field H parallel to the interface may propagate along the surface. By solving the Maxwell's equations in the absence of external sources, it can generally be classified into s-polarized and p-polarized electromagnetic modes, the electric field E and the magnetic filed H being parallel to the interface, respectively.

Further, by considering a classical model comprising two semi-infinite non-magnetic media with local (frequency-dependent) dielectric functions ε₁ and ε₂ separated by a planar interface at z=0 as shown in FIG. 1(d), Equations (2.2) and (2.3) in which the electric field E and magnetic field H are propagating along the x-direction, are obtained in the example embodiment:

Eᵢ=(Eᵢₓ, 0, E_{iz})e^{-κ}^{ᵢ}^{|z|}e^{i(q}^{ᵢ}^{x-ωt)} (2.2)

Hᵢ=(0, E_{iy}, 0)e^{-κ}^{ᵢ}^{|z|}e^{i(q}^{ᵢ}^{x-ωt)} (2.3)

where qᵢ is the magnitude of the wavevector which is parallel to the surface.

Next, aftersolving the above equations by substituting into Maxwell's equations, the following equations are obtained in the example embodiment:

$$\begin{matrix}{iκ}_{1} {H}_{1 y} = + \frac{ω}{c} {ɛ}_{1} {E}_{1 x} & ( 2.4 ) \\ {iκ}_{2} {H}_{2 y} = - \frac{ω}{c} {ɛ}_{2} {E}_{2 x} & ( 2.5 ) \\ {κ}_{i} = \sqrt{{k}_{i}^{2} - {ɛ}_{i} \frac{{ω}^{2}}{{c}^{2}}} & ( 2.6 )\end{matrix}$$

The boundary conditions imply that the component of the electric and magnetic fields parallel to the surface must be continuous. Using Equation (2.4) and (2.5), the following equations are derived in the example embodiment:

$$\begin{matrix}\frac{{κ}_{1}}{{ɛ}_{1}} {H}_{1 y} + \frac{{κ}_{2}}{{ɛ}_{2}} {H}_{2 y} = 0 & ( 2.7 ) \\ {H}_{1 y} - {H}_{2 y} = 0 & ( 2.8 ) \\ ⇒ \frac{{ɛ}_{1}}{{κ}_{1}} + \frac{{ɛ}_{2}}{{κ}_{2}} - 0 & ( 2.9 )\end{matrix}$$

Since the boundary conditions follow the continuity of a two-dimensional (2D) wavevector, the SP condition in the example embodiment can be expressed as follows:

$$k ( ω ) = \frac{{ω}_{0}}{c} \sqrt{\frac{{ɛ}_{1} {ɛ}_{2}}{{ɛ}_{1} + {ɛ}_{2}}} \qquad ( 2.10 )$$

where ω₀/C is the magnitude of the incident wave vector.

By applying the above derivations to the configuration in FIG. 1(c), the SP dispersion relation that is the frequency-dependent surface plasmon wavevector is obtained in the example embodiment:

$${k}_{SPW} ( ω ) = \frac{{ω}_{0}}{c} \sqrt{\frac{{ɛ}_{s} {ɛ}_{m}}{{ɛ}_{s} + {ɛ}_{m}}} \qquad ( 2.11 )$$

where εₘ is the dielectric constant of the metal and εₛ is the dielectric constant of dielectric 2 (i.e. corresponds to Equation (2) shown above).

For SPPs to exist on the interface, such as a metal-analyte interface, the real part of the complex dielectric constant for both media must be of opposite signs, which means Re(εₘ)<−Re(εₛ). Resonant excitation occurs when the wavevector of the evanescent wave k_{light} matches that of the SP, i.e.:

$${k}_{light} = \frac{{ω}_{0}}{c} \sqrt{{ɛ}_{d}} sin {θ}_{SP} = {k}_{SP} , \qquad ( 3 )$$

where θₛₚ is the resonance angle, ε_{d} is the dielectric constant of the glass substrate 105.

It will be appreciated that above equations are independent of the fluorescence beads as the SPR waves are generated in the dielectric medium, here, air. The SPR waves then excite the fluorescence beads (also known as the targets) disposed in the dielectric medium. It will also be appreciated that the dielectric medium may be air or water in embodiments where e.g. biological samples are being used.

Therefore, by selecting the two sets of diametrically opposed plane waves with incident angles of ±θₛₚ in the example embodiment, two counter-propagating SPP waves with wavevector of ±kₛₚ are generated.

Also, an OV is typically described as a dark channel with intensity profiles of a primary ring accompanied by concentric outer rings of diminishing intensities, where the primary ring scales approximately linearly with the topological charges of the OV. It is also referred to as a helical beam that can be produced by passing a plane wave through an azimuthally modulated phase mask with a transmission function of exp(ilθ), where l is the topological charge. In the example embodiment, the computer-generated hologram (CGH) patterns are provided with different types of topological charge (l) to modulate the radius of the OV 101 which focuses to the metal surface 105 (FIG. 1), to match the resonant condition in Equation (3). For example, it is understood that the radius Rₗ of the primary intensity ring depends on the topological charge:

Rₗ∝(l+1)^{1/2}, (4)

for l>0.

In the example embodiment, this dynamic characteristic of the OV is used to modulate the SPR angle by controlling the topological charges of the OV. Subsequently, the system of the example embodiment allows one to sequentially shift the phase of one-directional (1D) high frequency SPP interference patterns. In the example embodiment, utilizing these patterns, one can extract the high-spatial-frequency content of a targeted object through a diffraction-limited optical imaging system.

It will be appreciated that there are many practical ways to modulate the incident light beam to generate the OV beam, including but not limited to phase modulation of incident Gaussian beam by using spiral phase plate, holographic techniques such as imprinting computer generated holograms (CGHs) on the spatial light modulator (SLM), directly tuning laser cavity to produce the Laguerre-Gaussian (LG) beam modes, and using mode conversion of Hermite-Gaussian (HG) modes via cylindrical lens mode converters. In a preferred embodiment, the CGH technique is used due to e.g. greater ease of phase mask design.

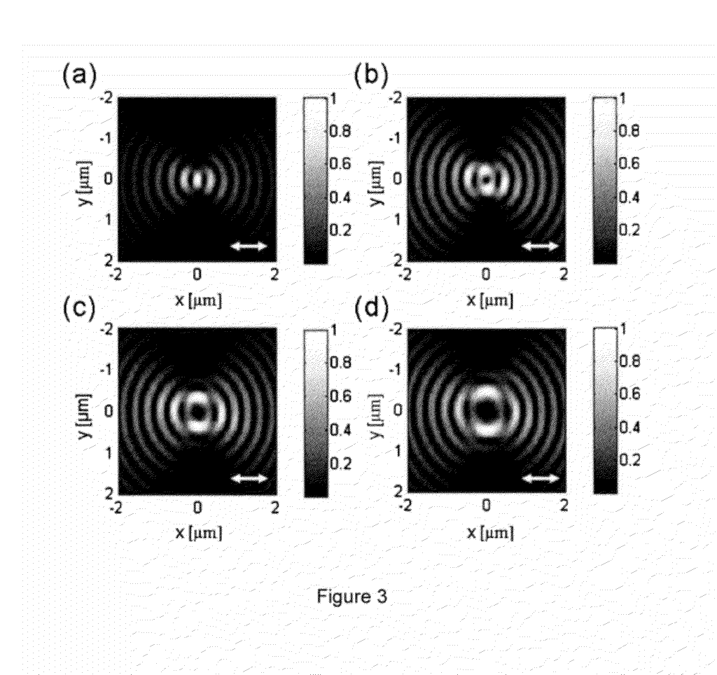

With reference to FIGS. 3 to 5, example simulation and experimental results of the method and system of the example embodiment are described. FIGS. 3(a)-3(d) show simulation results illustrating excitation intensity profiles generated by a linearly polarized OV beam having a topological charge of 1, 2, 3, 4 respectively for a silver/air interface. Here, one layer of fluorescent beads of about 20 nm in diameter is simulated as deposited on a silver (Ag) metal substrate. The SPR angle is approximately equal to 47° when the dielectric constant of Ag, εₘ=−17.81+0.68i at 633 nm. The simulations are implemented by using a FULLWAVE module of commercial RSOFT software, a method based on three-dimensional finite-difference time domain (FDTD). In the examples shown in FIGS. 3(a)-3(d), polarization direction of the linearly polarized OV is in the x-direction as indicated by the white arrow.

In FIGS. 3(a)-3(d), the fringe period is equal to about 310±5 nm originated from interfering SPPs with opposite wavevectors. The nodes and antinodes of this field, which are planes parallel to the focal plane, have a spacing of about λₛₚ/2. As such, the method and system of the example embodiment can substantially increase the magnitude of the evanescent wavevector, resulting in higher resolution.

For example, the equation for the wavevector, k, in an example embodiment is expressed as:

$$k = \frac{2 π}{λ} \qquad ( 5 )$$

In the example embodiment, the SPR wavelength λₛₚ is 620 nm, which is smaller than incident light wavelength λₒ, 633 nm. Therefore, the wavevector is increased accordingly by using Equation (5).

In an example embodiment, in order to generate the resolution enhanced standing-wave surface plasmon resonance fluorescence (SW-SPRF) image, a plurality of intermediate SPRF images, e.g. at least three, are captured at their respective phases. For example, the corresponding phase shift generated by the OV with l=1−4 is approximately equal to 0, 2π/5, 4π/5, and 6π/5 respectively, as measured directly from the simulation result. For example, the phase shift can be seen as the displacement of the interference fringe, as shown in FIG. 3. In some embodiments, the phase shift is derived from the optical path displacement, where phase shift=(displacement×2π)/λ.

Additionally, in the example embodiment, while the topological charge l, hence the phase, is modulated at the SLM 205 (FIG. 1), the resonance is still achieved through the use of the telescope system 207b (FIG. 1), which adjusts the size (i.e. radius Rₗ) of the optical vortex beam to meet resonance condition. In other words, the telescope system 207b compensates the changes in the radius R₁ in Equation (4) as topological charge l is modulated. The resonance condition can thus be achieved independent from the topological charge l in the example embodiment.

Also, due to the highly polarized and anisotropic emission caused by the metal layer, the PSF in FIG. 3 is irregular and has an annular-like structure, significantly different from the PSF of wide-field microscopy. In the example embodiment, a deconvolution algorithm is used to convert the doughnut-shaped SPRF PSF shown in FIG. 3 into an Airy disk-shaped PSF after numerical post-processing to overcome the above issues of a central dip in the PSF and a widening of the overall full width at half maximum (FWHM).

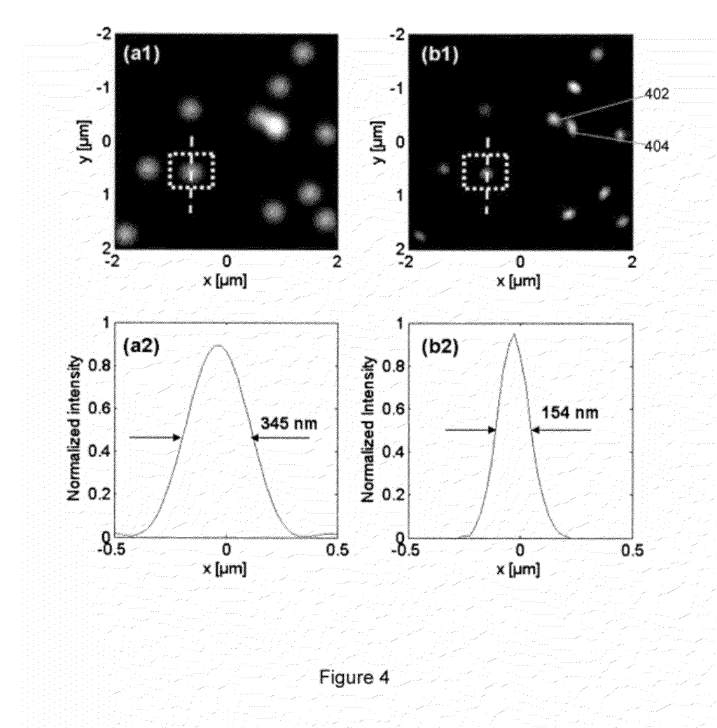

FIG. 4 shows simulation results comparing performance of a conventional TIRF technique (shown by FIGS. 4(a1) and 4(a2)) and the SW-SPRF method of the example embodiment (shown by FIGS. 4(b1) and 4(b2)). In the example embodiment, FIG. 4(b1) shows the enhanced image comprising three SPRF images illuminated by a linearly polarized OV beam with three different topological charges

The SPPs which can only be excited by p-polarized illumination light with both x and y directions are taken into account in the simulation model. In an example embodiment, orientation of the polarization direction is adjusted e.g. by rotating a half-wave plate in the experimental setup. Comparing FIGS. 4(a1) and 4(b1), it can be seen that the method of the example embodiment improves resolution substantially. For example, the adjacent fluorescent beads 402, 404 can be resolved by using the SW-SPRF method of the example embodiment, but not by conventional TIRF technique. FIGS. 4(a2) and 4(b2) show intensity profiles at the regions of interest marked by dotted boxes in FIGS. 4(a1) and 4(b1) respectively. By comparing the PSF intensity profiles in FIGS. 4(a2) and 4(b2), it can be seen that the FWHM of the SW-SPRF method of the example embodiment is more than a factor of 2 narrower than that of the conventional TIRF technique.

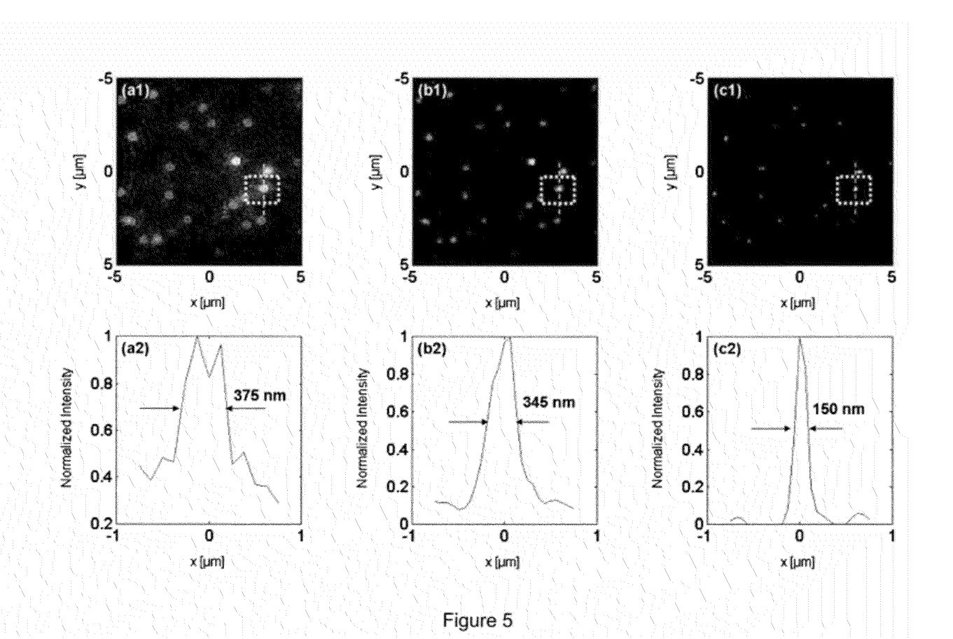

FIG. 5 shows experimental results after carrying out progressive steps of the fluorescence microscopy method according to a preferred embodiment. As described above, to generate an enhanced SW-SPRF image, three intermediate SPRF images are taken at three SW phases excited by the OV beam with three different topological charges. FIG. 5(a1) shows the doughnut-shaped image when the fluorescent excitation light is coupled back via the metal surface to the CCD camera. FIG. 5(a2) shows the PSF profile of the region of interest marked by the dotted box in FIG. 5(a1), confirming a dip in intensity.

In the example embodiment, the deconvolution algorithm is applied to convert the original doughnut-shaped PSFs (as shown in FIGS. 5(a1) and 5(a2)) into PSFs that are single-lobed using e.g. a surface-plasmon-coupled emission (SPCE) PSF kernel. FIGS. 5(b1) and 5(b2) show the result after the deconvolution step in which a single and relative sharp peak remains, i.e. resolution has been improved.

Further, in the example embodiment, the deconvolution step is followed by an application of the SW-TIRF algorithm. FIGS. 5(c1) and 5(c2) show the final result of the SW-SPRF resolution enhanced image, demonstrating that the FWHM of SW-SPRF is more than a factor of 2 narrower than that of the deconvolved SPRF PSF in FIG. 5(b2). The difference between the FWHM in FIG. 5(c2) and the FWHM in FIG. 4(b2) may be due to the resolution limit of the CCD camera 208 (FIG. 1).

As described above, the dynamic characteristic of OV beam provides an efficient mean to meet the resonant condition. The resonant condition can be modulated by proper design of the phase mask's topological charge with different metal/analyte configurations, as discussed in [P. S. Tan, X. C. Yuan, J. Lin, Q. Wang, T. Mei, R. E. Burge, and G. G. Mu, Appl. Phys. Lett. 92, 111108 (2008)], the contents of which are hereby incorporated by cross-reference.

The fluorescence microscopy method and system of the example embodiments offer better background suppression, smaller detection volume, and decreased fluorescence lifetime and photobleaching effect compared to conventional techniques such as TIRF microscopy. In addition, method and system the example embodiments provide greater flexibility. For example, the OV with different topological charges can be generated through the spatial light modulator with different phase masks without changing any optical or mechanical components. Further, as there is no mechanical stage involving moving parts, the system of the example embodiments is advantageously less sensitive to environment noise such as vibration, while at the same time achieving relatively high resolution for microscopy.

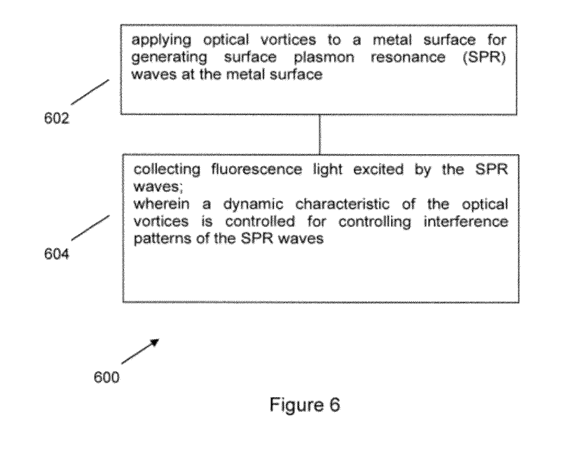

FIG. 6 shows a flow chart 600 illustrating a fluorescence microscopy method according to an example embodiment. At step 602, optical vortices are applied to a metal surface for generating surface plasmon resonance (SPR) waves at the metal surface. At step 604, fluorescence light excited by the SPR waves is collected; wherein a dynamic characteristic of the optical vortices is controlled for controlling interference patterns of the SPR waves.

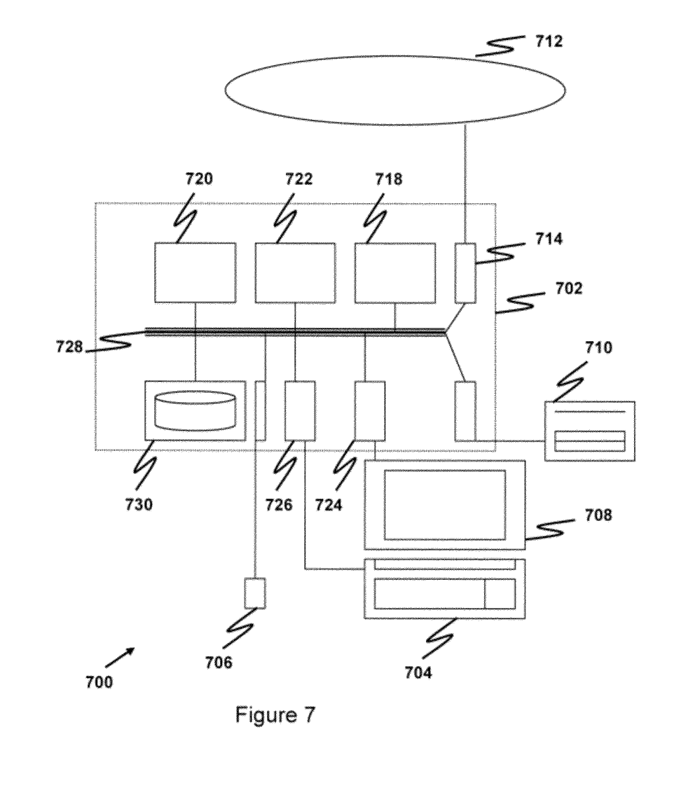

The method and system of the example embodiment can be implemented on a computer system 700, schematically shown in FIG. 7. It may be implemented as software, such as a computer program being executed within the computer system 700, and instructing the computer system 700 to conduct the method of the example embodiment.

The computer system 700 comprises a computer module 702, input modules such as a keyboard 704 and mouse 706 and a plurality of output devices such as a display 708, and printer 710.

The computer module 702 is connected to a computer network 712 via a suitable transceiver device 714, to enable access to e.g. the Internet or other network systems such as Local Area Network (LAN) or Wide Area Network (WAN).

The computer module 702 in the example includes a processor 718, a Random Access Memory (RAM) 720 and a Read Only Memory (ROM) 722. The computer module 702 also includes a number of Input/Output (I/O) interfaces, for example I/O interface 724 to the display 708, and I/O interface 726 to the keyboard 704.

The components of the computer module 702 typically communicate via an interconnected bus 728 and in a manner known to the person skilled in the relevant art.

The application program is typically supplied to the user of the computer system 700 encoded on a data storage medium such as a CD-ROM or flash memory carrier and read utilising a corresponding data storage medium drive of a data storage device 730. The application program is read and controlled in its execution by the processor 718. Intermediate storage of program data maybe accomplished using RAM 720.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A fluorescence microscopy method, comprising the steps of:
applying optical vortices to a metal surface for generating surface plasmon resonance (SPR) waves at the metal surface; and
collecting fluorescence light excited by the SPR waves;
wherein a dynamic characteristic of the optical vortices is controlled for controlling interference patterns of the SPR waves.

2. The method as claimed in claim 1, wherein the dynamic characteristic of the optical vortices comprises a topological charge, the method further comprising controlling a radius of the optical vortices based on the topological charge.

3. The method as claimed in claim 2, further comprising modulating a phase of the interference patterns based on the topological charge.

4. The method as claimed in claim 3, further comprising generating at least three intermediate images each corresponding to a respective phase.

5. The method as claimed in claim 4, further comprising applying a deconvolution algorithm to the intermediate images to convert original point spread functions (PSFs) into single-lobed PSFs.

6. The method as claimed in claim 2, wherein the radius is matched against an SPR angle corresponding to a respective sample.

7. A fluorescence microscopy system, comprising:
means for applying optical vortices to a metal surface for generating surface plasmon resonance (SPR) waves at the metal surface;
means for collecting fluorescence light excited by the SPR waves; and
means for controlling a dynamic characteristic of the optical vortices for controlling interference patterns of the SPR waves.

8. The system as claimed in claim 7, wherein the dynamic characteristic of the optical vortices comprises a topological charge, and wherein the means for controlling the dynamic characteristic of the optical vortices controls a radius of the optical vortices based on the topological charge.

9. The system as claimed in claim 8, further comprising means for modulating a phase of the interference patterns based on the topological charge.

10. The system as claimed in claim 9, further comprising means for generating at least three intermediate images each corresponding to a respective phase.

11. The system as claimed in claim 10, further comprising means for applying a deconvolution algorithm to the intermediate images to convert original point spread functions (PSFs) into single-lobed PSFs.

12. The system as claimed in claim 8, wherein the radius is matched against an SPR angle corresponding to a respective sample.
